(19) United States
(12) Patent Application Publication
(10) Pub. No.: US 2011/0017476 A1
(43) Pub. Date: Jan. 27, 2011

(54) FIRE-EXTINGUISHING UNIT FOR A STORAGE SYSTEM

(76) Inventor: Peter Fuchs, Rheinstetten (DE)

Correspondence Address: RABIN & Berdo, PC, 1101 14TH STREET, NW, SUITE 500, WASHINGTON, DC, 20005, US

(21) Appl. No.: 12/922,412

(22) PCT Filed: Mar. 13, 2009
(86) PCT No.: PCT/EP2009/001865

§ 371 Date: Sep. 13, 2010

(30) Foreign Application Priority Data
Mar. 14, 2008 (DE) 10 2008 014 446.0
Apr. 22, 2008 (DE) 10 2008 020 015.8

(51) Int. Cl. A62C 35/00

(52) U.S. Cl. 169/11

(57) ABSTRACT

In order to ensure fast and reliable fire-extinguishing units in a storage system (10), a fire-extinguishing unit based on the inertization principle is proposed, in which either homogeneous flooding of the entire storage system (10) or targeted flooding of risk areas is ensured. To this end, in particular vertically extending quenching gas channels (62) comprising a plurality of quenching gas outlet openings (66), each group of quenching gas outlet openings (56) being associated with a flooding area (F1 to F3), or a quenching gas distribution line having a plurality of spray nozzles are provided.

### TECHNICAL FIELD OF INVENTION

The invention relates to a fire-extinguishing unit operating based on the inertization principle and used for a storage system as defined in the preamble to claim 1, as well as to a fire-extinguishing unit operating based on the inertization principle and used for a storage system as defined in the preamble to claim 17.

The method of extinguishing a fire based on the inertization principle has long been known in the technical field. The principle is based on supplying inert gas or a quenching gas consisting of environmental air and an inert gas to a space in which a fire has broken out, thus lowering the oxygen content to below 13% and suffocating the fire due to a lack of oxygen.

### STATE OF THE TECHNOLOGY

Owing to a lack of space, storage systems are increasingly used in industry, which take the form of high-bay systems or Paternoster assemblies. A storage system of this type comprises at least one storage area divided into a plurality of individual areas, namely the individual compartments or shelves. The aforementioned fire-extinguishing units operating based on the inertization principle are also used for storage systems of this type. The results, however, are for the most part unsatisfactory because either large amounts of inert gas are required or the time for securely extinguishing a fire is unacceptably high.

### SUBJECT MATTER OF THE INVENTION

Starting with this premise, it is the object of the present invention to further develop a fire-extinguishing unit of the generic type in such a way that a quick and secure extinguishing of the fire with relatively small amounts of inert gas can be achieved.

This object is solved with a fire-extinguishing unit having the features as disclosed in claim 1 and/or a fire-extinguishing unit having the features as disclosed in claim 17.

The generic-type fire-extinguishing units used so far are provided with a quenching gas distribution system which has quenching gas outlet openings at a few locations inside the storage system. The inside of the storage system is flooded with the aid of these quenching gas outlet openings. However, it has turned out that because of the complex internal geometry of such a storage system, in particular because of the relatively tight sealing of individual areas against each other, it is difficult to achieve a homogeneous gas mixture on the inside of the storage system, so that it is left up to chance whether or not at the location of the fire the oxygen concentration drops to below 13% after just a short time.

It is therefore proposed according to the invention to arrange the quenching gas outlet openings in such a way in the storage system that these outlets either ensure an essentially simultaneous homogeneous flooding of the complete inside space of the storage system, and/or to arrange the quenching gas openings in such a way that at least some of the quenching gas outlet openings are respectively assigned directly to a partial risk area, such that the flooding of these partial risk areas does not occur randomly but at a targeted location.

According to a first embodiment of the invention, which is disclosed in claims 1 to 16, it is the object to produce in the shortest possible time and using the lowest possible amount of inert gas as gas mixture inside the storage system for which the oxygen share is less than 13%. For this, the quenching gas distribution system is provided with at least one substantially vertically extending section that contains several quenching gas outlet openings, vertically offset relative to each other, so that the quenching gas, which essentially flows in horizontally, makes it possible to achieve an essentially simultaneous and homogeneous inertization of the inside space of the storage system. However, since corresponding storage systems are frequently embodied with extreme height, additional means are provided for influencing or adjusting the amount of quenching gas exiting from a quenching gas outlet opening or a group of quenching gas outlet openings, relative to a vertically offset quenching gas outlet opening or a group of quenching gas outlet openings. As a result of these means, an actual homogeneous flooding can be achieved in practically all cases, even for a storage system of extreme height.

The dependent claims 2 to 16, as well as the exemplary embodiments described in the following, disclose means for adjusting the amount of quenching gas exiting the individual quenching gas outlet openings or groups of quenching gas outlet openings.

A second embodiment of the invention discloses the targeted flooding with quenching gas of some partial risk areas, in particular involving motors, electronic control units and the like.

The two embodiments of the invention are now explained in further detail with the aid of examples, showing in:

### SHORT DESCRIPTION OF THE DRAWINGS

FIG. 1 A schematic representation of a storage system, shown as isometric representation;

FIG. 2 A schematic representation of a first example of a first embodiment of the invention, showing a representation that essentially corresponds to the one in FIG. 1;

FIG. 3 The quenching gas channels from FIG. 2;

FIG. 4 A variation of the isometric representation shown in FIG. 3;

FIG. 5 A variation of the embodiments shown in FIGS. 3 and 4;

FIG. 6 A second example of the first embodiment of the invention in a sectional representation;

FIG. 7 A third example of the first embodiment of the invention, shown as a sectional representation;

FIG. 8 A nozzle tube as shown in FIG. 7;

FIG. 8a A section along the plane A-A in FIG. 8;

FIG. 9 A section of a nozzle casing tube segment from FIG. 7;

FIG. 9a A section along the plane B-B in FIG. 9;

FIG. 10 The nozzle tube and the nozzle casing tube segment shown in FIGS. 8 and 9; in the fully assembled state;

FIG. 10a A section along the plane C-C in FIG. 10;

FIGS. 11a-11d The representation from FIG. 10a, showing different positions for the nozzle casing tube segment, relative to the nozzle tube;

FIG. 12 A fourth example of the first embodiment of the invention in a view from the side;

FIG. 13 A detail from FIG. 12;

FIG. 14 A section along the plane D-D in FIG. 13;

FIG. 15 A fourth example of the first embodiment of the invention in a side view

FIG. 16 A variation of the representation shown in FIG. 15;

FIG. 17 A further variation of the representation shown in FIG. 15;

FIG. 18 A nozzle tube extending inside a hollow profile of a storage system, shown as an isometric view;

FIG. 19 A second example of the invention, in a representation corresponding to FIG. 1;

FIG. 20 A second example of the second embodiment in a representation corresponding to FIG. 19;

FIG. 21 A basic outline for the storage system shown in FIG. 19; and

FIG. 22 A conveying device provided with an inert gas spray nozzle.

### DESCRIPTION OF THE PREFERRED EMBODIMENTS

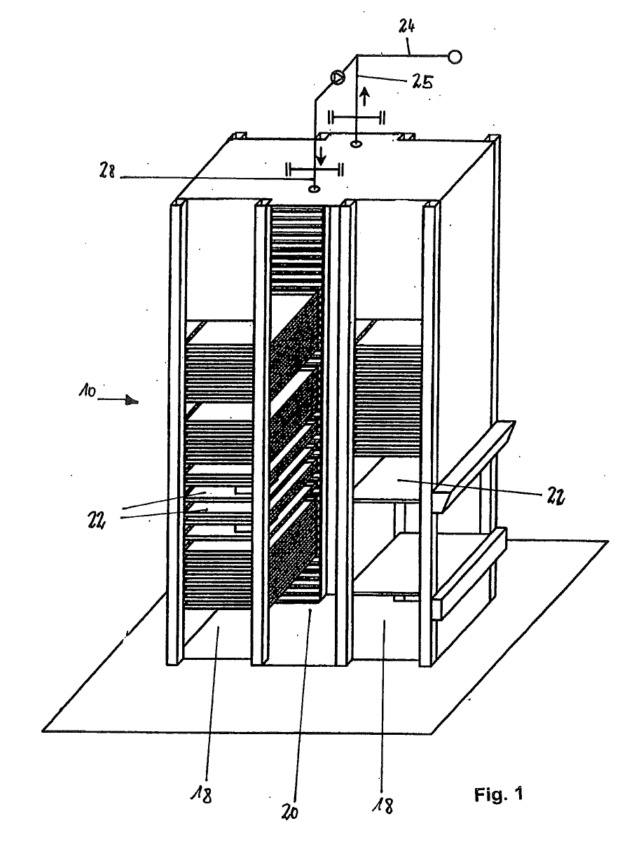

FIG. 1 shows a schematic, isometric representation of a storage system 10. The storage system comprises a transport area 20 and two storage areas 18 that are located adjacent to the transport area. The storage areas 18 are subdivided into a plurality of individual areas 22 in the form of shelves. A fire-extinguishing unit is provided which operates based on the inertization principle. For this, an inert gas line 24 is provided which is connected to an existing inert gas grid or a corresponding tank. A quenching gas distribution system with a quenching gas supply line 28 is provided within the storage system 10, which can be supplied exclusively with inert gas from the inert gas line 24 or with a mixture of inert gas and environmental air from the inside of the storage system 10, for which an internal air-return line 25 is provided. In the following, only the term quenching gas is used, regardless of whether it refers to a quenching gas mixture or to pure inert gas. If the storage system is a completely closed system, then an excess pressure opening 76 must be provided.

With a first embodiment, such as the one described initially with the aid of numerous examples, the goal is to flood the inside of the storage system quickly, at the same time and evenly with quenching gas (which can also be pure inert gas), in particular all individual areas (shelves) 22. A central shut-off valve 84 is provided in this case, which admits the quenching gas feed line 28 and thus the quenching gas distribution system with quenching gas if a fire alarm issues a corresponding signal. It is clear that several quenching gas feed lines with synchronously operating shut-off valves can also be provided.

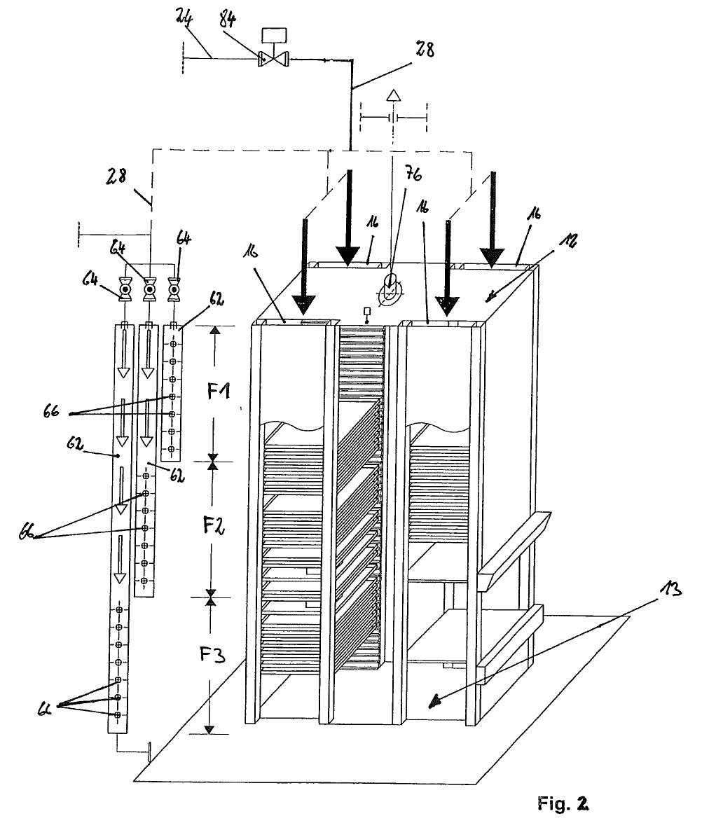

FIG. 2 shows a storage system which is similar to the storage system shown in FIG. 1 and is provided with a fire-extinguishing unit of the same type as the first example of the first embodiment. The illustrated example is shown with clearance spaces 16, in this case four, between the individual areas (shelves) 22 and the outside wall. In each of these clearance spaces 16, three separate quenching gas channels 62 belonging to the quenching gas distribution system extend from the top to the bottom, wherein each of these quenching gas channels 62 comprises a group of quenching gas outlet openings 66 and is connected via a volume-control valve 64 to the quenching gas feed line 28. The four structural groups, formed with respectively three quenching gas channels, are configured identical and arranged at the same level. The number and position of the quenching gas outlet openings 66 is configured such that at least one quenching gas outlet opening 66 is assigned to each possibly existing individual area. The groups of quenching gas outlet openings 66 are offset vertically, relative to each other, and are assigned to respectively one flooding region F1 to F3, which are arranged vertically one above the other. Each group of quenching gas outlet openings 66 is assigned a flow control valve 64, so that the amount of quenching gas exiting from a group of quenching gas outlet openings 66 can be adjusted, relative to the vertically offset quenching gas outlet openings 66, thus ensuring a homogeneous flooding.

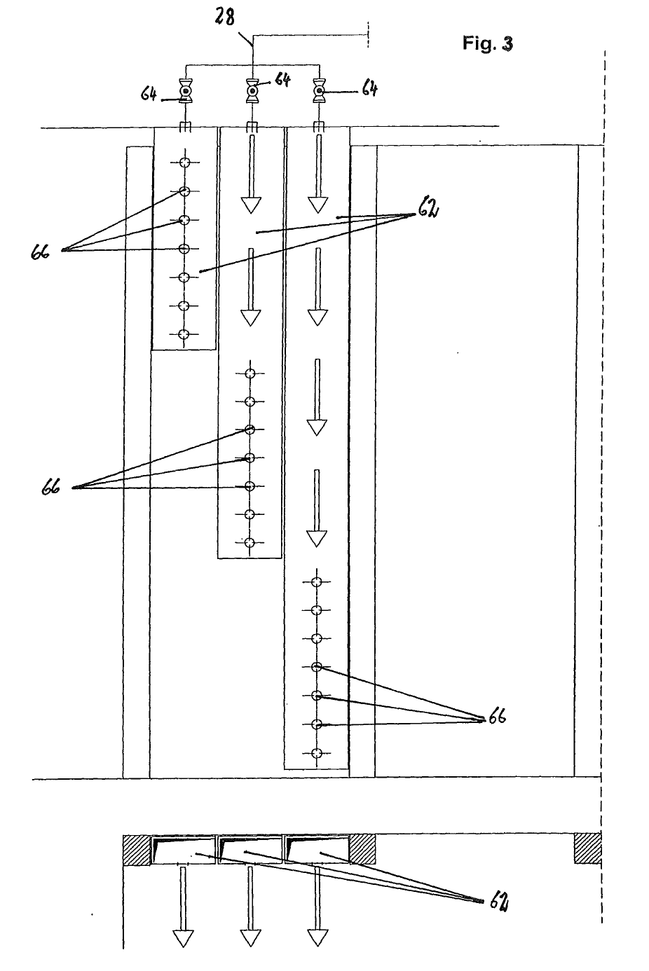

FIG. 3 shows a group of quenching gas channels 62 from FIG. 2. One can see that the quenching gas essentially exits in horizontal direction.

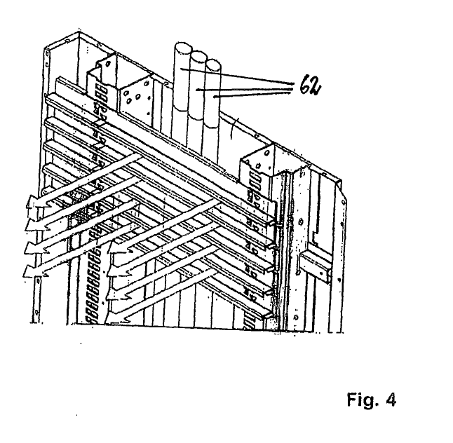

FIG. 4 shows a different installation situation for the separate channels or tubes 62, wherein these are located in the clearance spaces on the side of the mounting rails for the shelves.

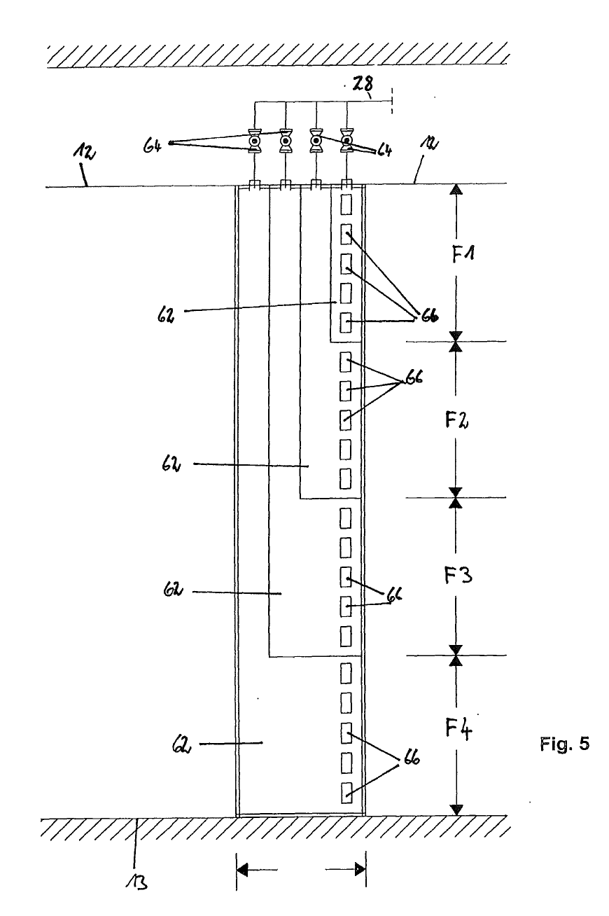

FIG. 5 shows a variant of the above-described example. Several separate quenching gas channels 62, namely four channels, are provided in this case as well for each structural component, wherein each quenching gas channel 62 comprises a group of quenching gas outlet openings 66 for the quenching gas. In this case, the vertically offset groups of quenching gas outlet openings are arranged one directly above the other. Each group of quenching gas outlet openings is assigned to a flooding section F1 to F4 and each channel 62 is connected via a separate volume control valve 64 to the inert gas line 24. The individual channels 62 in this case have an approximately L-shaped form (except for the shortest one) and form a compact assembly. The aforementioned statements relating to the adjustability of the quenching gas amounts and the desired number and arrangement of the quenching gas outlet openings are also valid in this case. It can be seen easily that the adjoining flooding sections extend from the floor 13 to the roof 12 of the storage system.

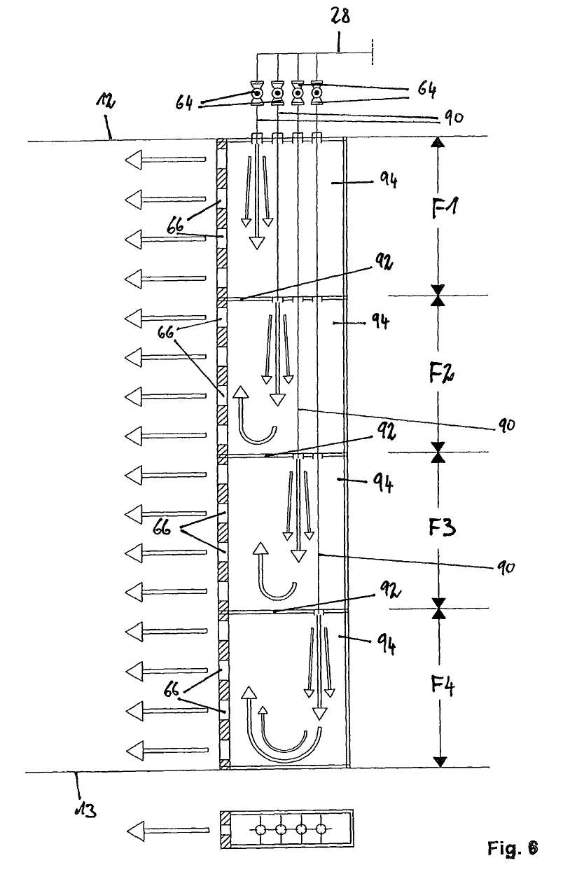

FIG. 6 shows a second example of the first embodiment. Again, there are four flooding sections F1 to F4 which are arranged vertically one above the other. Each flooding section F1 to F4 is assigned a chamber 94, wherein the chambers 94 are separated by molded parts 92 which are inserted into a hollow structural part of the storage system 10 and for which the vertical position can be selected. Analog to the first example, several such chamber-type arrangements can be provided in the storage system at different locations. Each chamber has a plurality of quenching gas outlet openings 66 which form a group of quenching outlet openings, as in the first example, and are also assigned to the individual flooding sections F1 to F4. Each chamber 94 is connected by means of a separate, vertically extending quenching gas line 90 via a volume control valve 64 to the quenching gas feed line 28, so that the basic function corresponds to that of the first example. In particular, the quenching gas outlet openings 66 can be bores or openings in an inside wall of a structural part of the storage system in this case. The chambers 94, arranged vertically one above the other, together with the quenching gas lines 90 consequently form the quenching gas distribution system. For this example, the quenching gas amounts are also adjusted via the volume control valve 64.

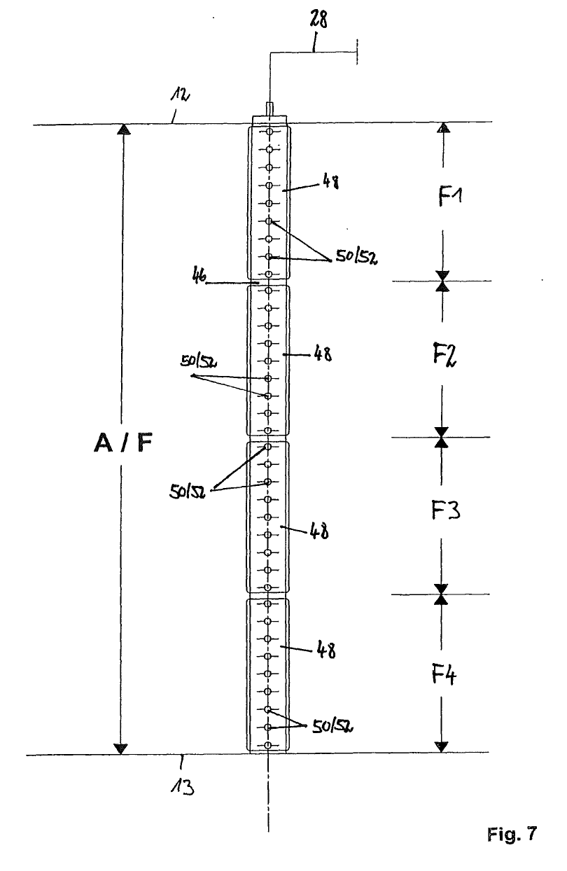

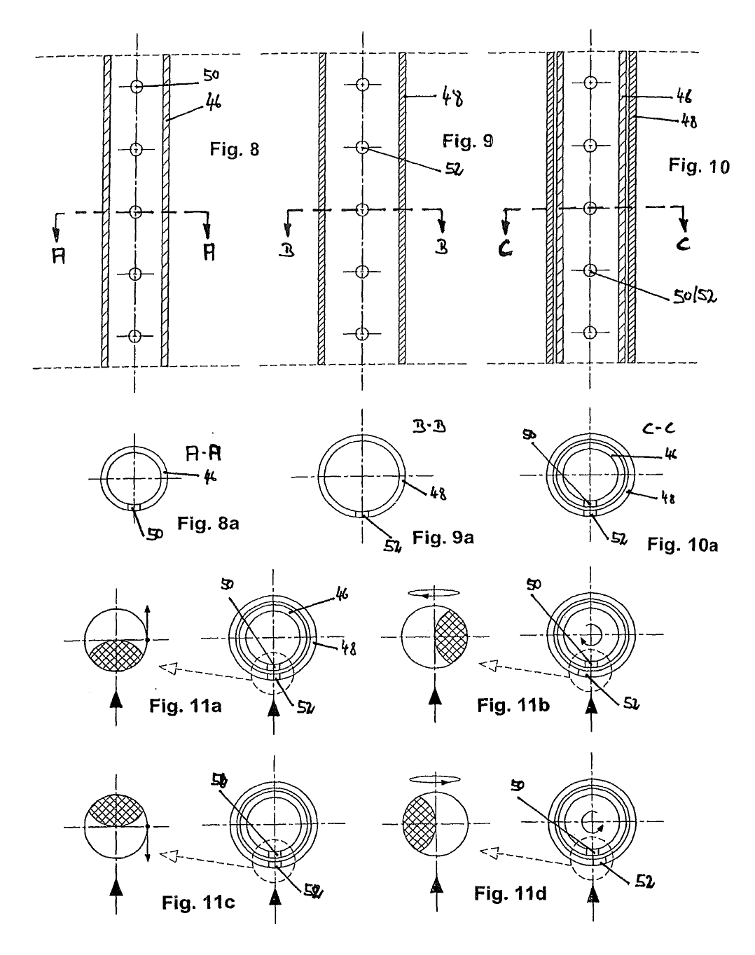

FIGS. 7 to 11 show a third example of the first embodiment of the invention. In this case, a nozzle tube 46 that is connected to the gas feed line 28 extends essentially vertically over the total height of the storage system 10 (FIG. 7). Arranged on the nozzle tube 46 are four nozzle casing tube segments 48, which divide the nozzle tube 46 into four flooding sections F1 to F4. As can be seen in FIGS. 8 to 11, each nozzle casing tube segment 48 has for each bore 50 in the nozzle tube (first bore) a second bore 52 in the nozzle casing (second bore). Respectively a first and a second bore, arranged one above the other, jointly form a quenching gas outlet bore. As a result of turning and/or vertically displacing a nozzle casing tube segment 48, relative to the nozzle tube 48 [sic], the effective cross section of respectively one group of quenching gas outlet openings 66 can be changed. The maximum cross section is obtained if the bores 52 of the nozzle casing tube segment 48 come to rest precisely above the bores in the nozzle casing, as shown with FIG. 10a. Starting with this, the effective cross section can be gradually reduced to 0, wherein the outflow direction can also be changed through turning and/or displacing. Thus, by turning and/or displacing the individual nozzle casing tube segments 48, the amount of the quenching gas exiting from a group of quenching gas outlet openings can be adjusted relative to the other groups of quenching gas outlet openings. As a rule, several such nozzle tubes are provided distributed over the storage system, which jointly form the quenching gas distribution system.

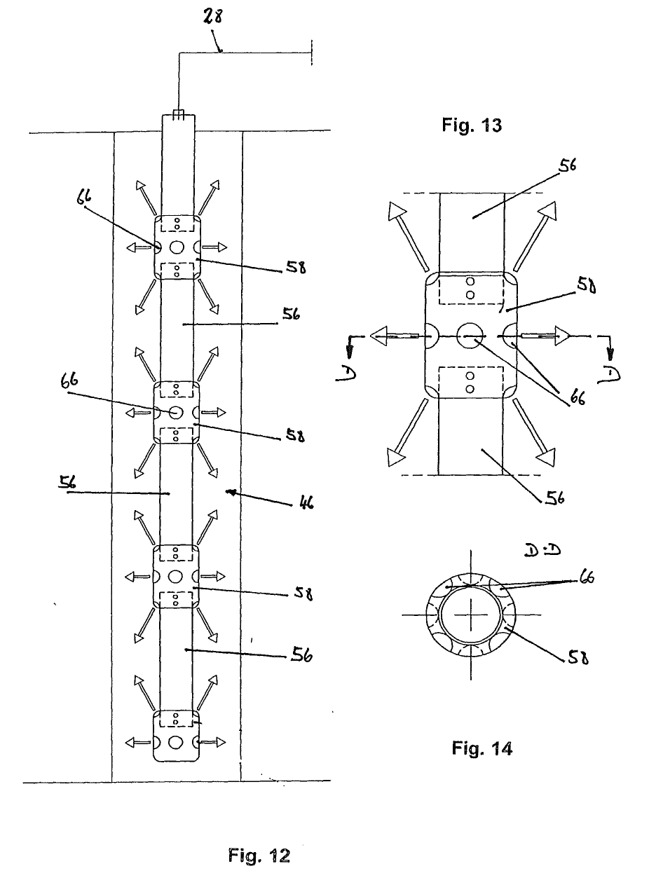

FIGS. 12 to 14 show a variation of the aforementioned, wherein FIG. 13 represents a detailed view from FIG. 12 and FIG. 14, showing a section along the plane D-D in FIG. 13. The nozzle tube 46 in this case is composed of several tube segments 56 which are connected via couplings 56, arranged vertically one above the other. The couplings 58 are provided with quenching gas outlet openings 66, so that each coupling 58 is assigned a flooding section. The total cross sections of the individual couplings can differ, so that here too the amount of quenching gas which exits the group of quenching gas outlet openings can be adjusted, relative to the remaining groups of quenching gas openings.

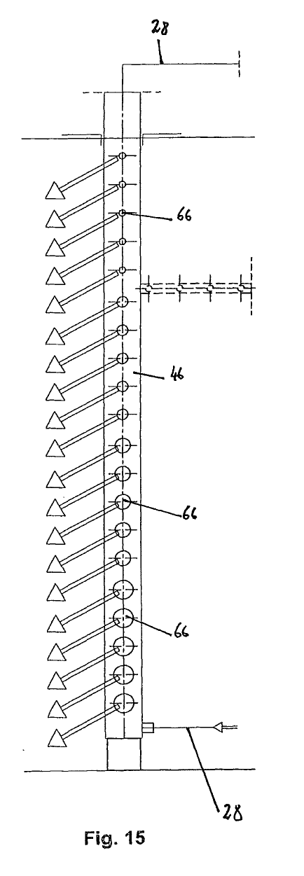

FIG. 15 shows a different example of the first embodiment of the invention. Several quenching gas outlet openings 66 with different cross sections are arranged here in a vertically extending nozzle tube 46. In this case, quenching gas can be supplied from both ends of the nozzle tube 46, so that the amount of quenching gas exiting at the upper quenching gas outlet openings can be adjusted relative to the amount of quenching gas exiting at the lower quenching gas opening.

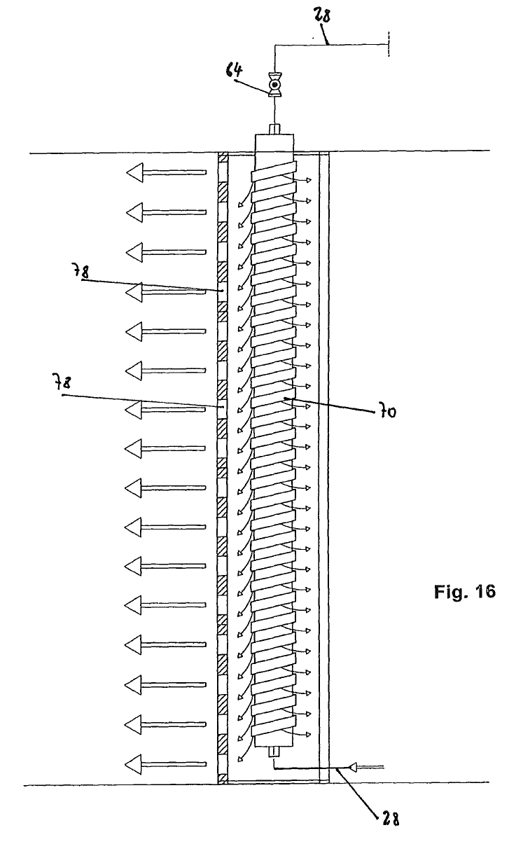

FIG. 16 shows a variation of the representation shown in FIG. 15. A vertically extending quenching gas hose 70 with perforated walls is provided here, meaning a hose with a large number of quenching gas outlet openings. This quenching gas hose 70 is guided vertically inside a hollow space of the storage system which has a plurality of openings 78 for allowing the quenching gas to pass through. Two quenching gas connections are provided in this case as well, so that the quenching gas amount exiting in an upper region can be adjusted relative to the quenching gas amount exiting in a lower region.

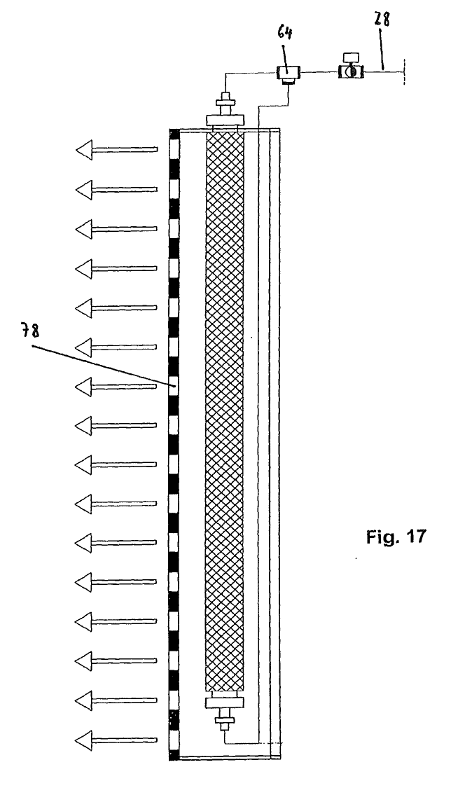

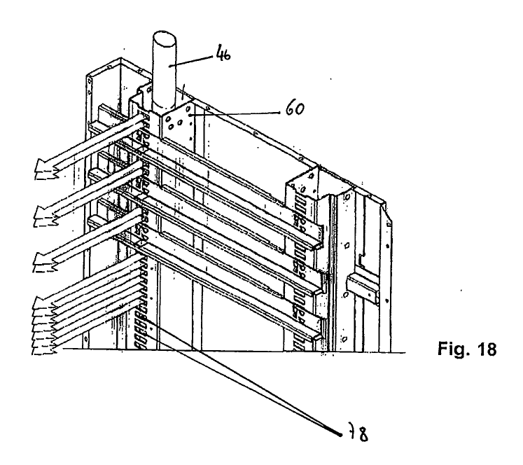

FIG. 17 shows the features of FIG. 16 with a braided, gas-permeable metal hose. For the example shown herein, the volume control valve 64 is embodied such that the arriving gas flow can be divided into two partial gas flows.

FIG. 18 shows how a nozzle tube 46 or a quenching gas hose of the type as described in the above can be installed in a hollow profile 60 of a storage system. It is thus obvious that existing systems can also be retrofitted easily with nozzle tubes/distribution lines of this type.

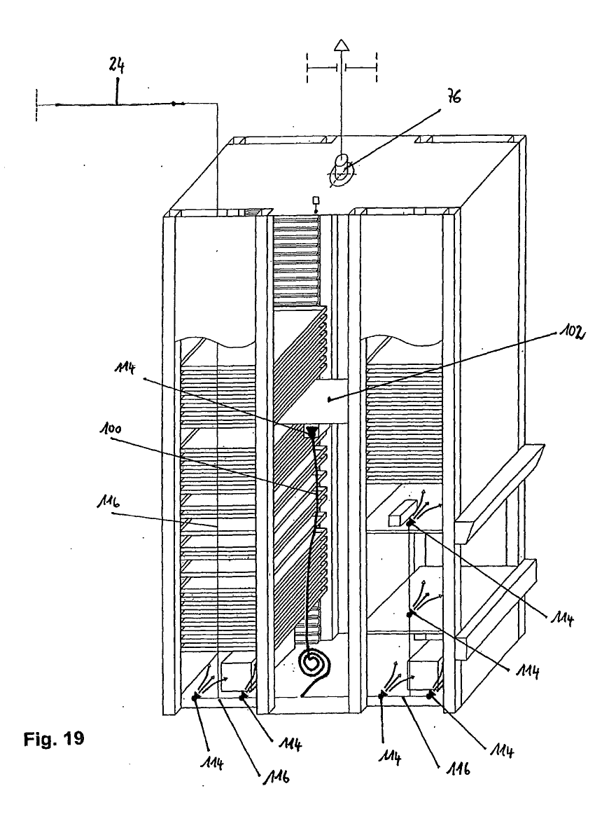

FIGS. 19 to 22 show a storage system with a fire-extinguishing unit according to a second embodiment of the invention. In this case, several spray nozzles 114 are connected to a quenching gas distribution line 116 and are respectively assigned directly to a risk area. The quenching gas distribution line 116 is preferably supplied with pure inert gas. The aforementioned risk areas in particular can refer to the drive motors. At least one spray nozzle 114 is connected via a flexible quenching gas line 100 to the quenching gas distribution line 116 and is attached to the conveying device 102 that is located in the transport region 20.

In a first example, shown in FIG. 19, the quenching gas distribution line 116 is permanently subjected to pressure and each spray nozzle is provided with a mechanical thermo element which closes off the spray nozzle under normal environmental temperature conditions. This thermo element can be embodied as a small glass cask, such as is known from traditional sprinklers. Once the environmental temperature around a spray nozzle exceeds a specified value, the thermo element reacts (the small glass casket bursts), the nozzle opening is released and the associated risk area is flooded with inert gas.

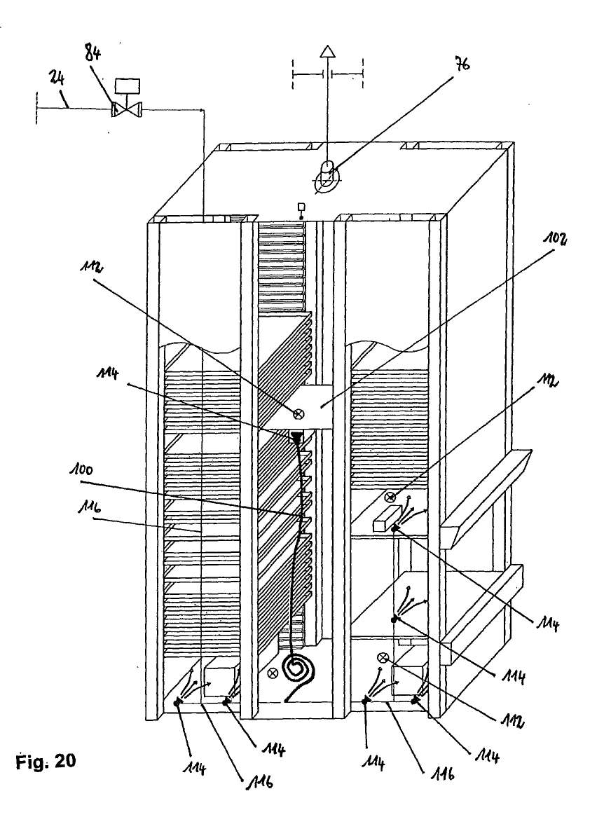

In a second embodiment shown in FIG. 20, a central fire sensor is provided at the roof 12 of the storage system, and decentralized fire sensors 112 are provided which are assigned to the risk areas. The quenching gas distribution 116 has no pressure in the idle state. Once a fire is detected by one of the fire sensors, a central shut-off valve 84 is opened which puts the complete, previously non-pressurized, quenching gas distribution line 116 under pressure, so that upon the detection of a fire all risk areas are flooded simultaneously. The spray nozzles 114 in this case are always open, meaning they are only quenching gas outlet openings.

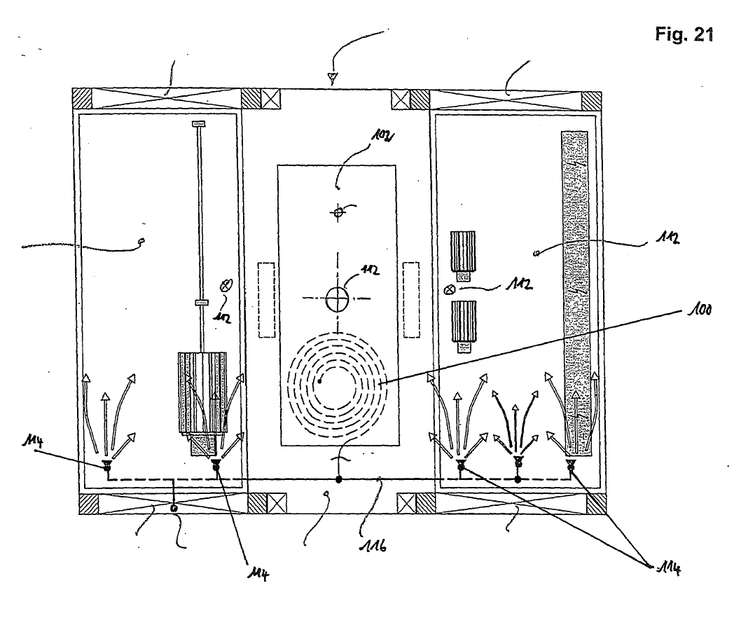

FIG. 21 shows the basic outline of a storage system according to FIG. 19.

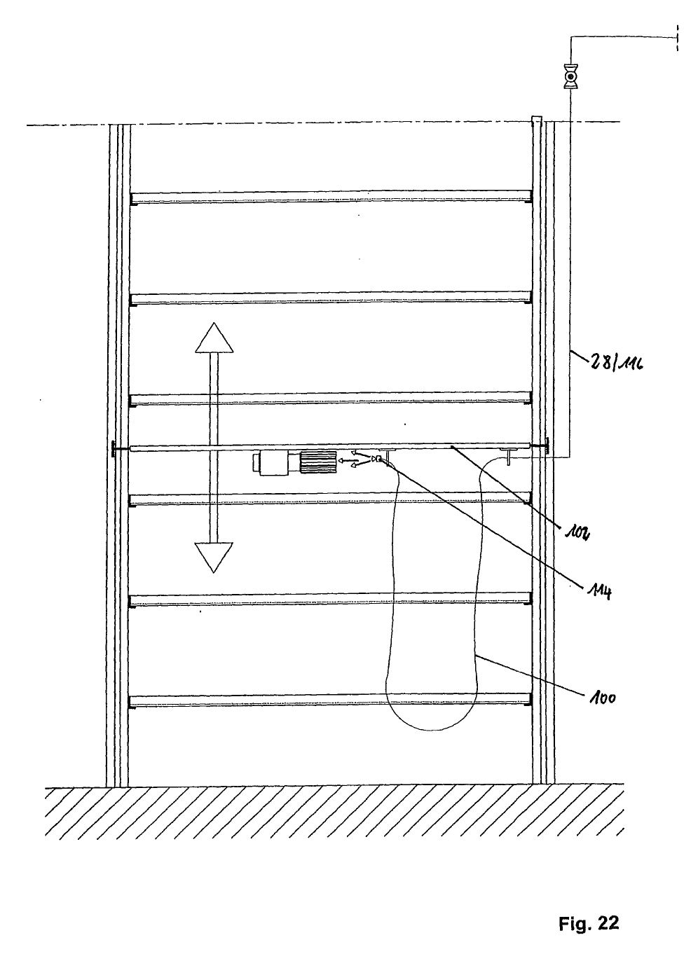

It follows from FIGS. 19 and 20 and is again shown in FIG. 22 that it may be advantageous to assign a spray nozzle 114 to the conveying device 102, which nozzle is connected via a flexible quenching gas line 100 to the quenching gas distribution line 116.

It is possible and in many cases also makes sense to combine the first and the second embodiments of the invention.

### REFERENCE NUMBER LIST

10 storage system
12 roof of the storage system
13 floor of the storage system
14 hollow profile
16 clearance space
18 storage area
20 transport area
22 individual areas (shelves)
24 inert gas line
25 inside air return line
28 quenching gas feed line
46 nozzle tube
48 nozzle casing tube segment
50 bore in the nozzle tube
52 bore in the nozzle casing
54 quenching gas distribution line
56 tube segment
58 coupling
60 hollow profile
62 quenching gas channels
64 volume control valve
66 quenching gas outlet opening
70 quenching gas hose
76 excess pressure opening
78 opening
84 shut-off valve
90 quenching gas line
92 molded part
94 chamber
100 flexible quenching gas line
102 conveying device
110 excess pressure opening
112 fire sensor
114 spray nozzle
116 quenching gas distribution line

1. A fire-extinguishing unit that operates based on the inertization principle, for a storage system (10) comprising at least one storage area (18) divided into several individual storage areas (22), wherein the fire-extinguishing unit comprises a quenching gas distribution system with several quenching gas outlet openings (66), characterized in that the quenching gas distribution system has at least one essentially vertically extending section that is provided with several quenching gas outlet openings (66), which are vertically offset relative to each other, wherein means are provided for influencing or adjusting the amount of quenching gas exiting a quenching gas outlet opening or a group of quenching gas outlet openings, relative to a vertically offset quenching gas outlet opening or a group of quenching gas outlet openings.

2. The fire-extinguishing unit according to claim 1, characterized in that the vertically extending section of the quenching gas distribution system comprises at least one nozzle tube (46) with first bores (50) and several nozzle casing tube segments (48) provided with second bores (52), wherein the positions of the nozzle casing tube segments (48), relative to the nozzle tube (46), can be adjusted by turning and/or displacing it, so as to adjusted the quenching gas amount exiting from the second bores (52) of a nozzle casing tube segment (48).

3. The fire-extinguishing unit according to claim 1, characterized in that the vertically extending section is a vertically extending tube or a vertically extending hose provided with several quenching gas outlet openings (66), wherein both ends of the tube are connected to the quenching gas supply.

4. The fire-extinguishing unit according to claim 3, characterized in that the vertically extending tube/hose has a gas-permeable wall.

5. The fire-extinguishing unit according to claim 3, characterized in that the quenching gas outlet openings (66) of the tube have different diameters.

6. The fire-extinguishing unit according to claim 1, characterized in that the tube comprises several tube segments (56) which are connected via couplings (58), wherein at least one coupling (58) is provided with a quenching gas outlet opening (66).

7. The fire-extinguishing unit according to claim 1, characterized in that the tube or the hose is guided inside a hollow profile or a hollow space of the storage system.

8. The fire-extinguishing unit according to claim 1, characterized in that the vertically extending section of the quenching gas distribution system comprises several separate channels (62) or tubes, wherein each channel/each tube comprises a group of outlet openings (66), wherein the groups of outlet openings are vertically offset, relative to each other, and wherein the channels or tubes are connected separately to a quenching gas supply.

9. The fire-extinguishing unit according to claim 8, characterized in that the channels/tubes have different lengths.

10. The fire-extinguishing unit according to claim 8, characterized in that each channel/each tube is connected via a separate valve (control valve 64) to the quenching gas supply.

11. The fire-extinguishing unit according to claim 9, characterized in that the channels and the quenching gas outlet openings form a part of the structure of the storage system.

12. The fire-extinguishing unit according to claim 8, characterized in that the tubes are flexible and can be used to retrofit a storage system.

13. The fire-extinguishing unit according to claim 1, characterized in that the vertically extending section comprises several separate chambers (94), arranged one above the other, which are connected via separate lines (90) to the quenching gas supply.

14. The fire-extinguishing unit according to claim 13, characterized in that the chambers (94) are separated with the aid of molded parts (92), for which the vertical position can be determined

15. The fire-extinguishing unit according to claim 1, characterized in that at least one quenching gas outlet opening (66) is assigned to each possibly existing individual area (22) of the storage system.

16. The fire-extinguishing unit according to claim 1, characterized in that all individual areas (22) of the storage system are flooded simultaneously.

17. A fire-extinguishing unit, operating based on the inertization principle, for a storage system (10) which comprises at least one storage area (18), divided into several individual areas (22), wherein the fire-extinguishing unit has a quenching gas distribution line (116) with several quenching gas outlet openings (spray nozzles 114),
characterized in that at least some of the quenching gas outlet openings are assigned directly to an area of risk.

18. The fire-extinguishing unit according to claim 17, characterized in that the risk areas comprise the electric/electronic units of the storage system.

19. The fire-extinguishing unit according to claim 17, characterized in that the storage system is provided with a dynamic conveying device (102) and that a flexible quenching gas line (110) with a quenching gas outlet opening is assigned to this conveying device.

20. The fire-extinguishing unit according to claim 17, characterized in that a fire sensor (112) is assigned directly to at least some of the partial areas of risk.

21. The fire-extinguishing unit according to claim 17, characterized in that the quenching gas outlet openings are respectively closed off with a thermo-element which releases the respective quenching gas outlet opening when a specified temperature is exceeded.

22. The fire-extinguishing unit according to claim 1, characterized in that the storage system (10) is a closed system.

23. The fire-extinguishing unit according to claim 22, characterized in that the storage system comprises at least one transport area (20) and at least one storage area (18) that adjoins the transport area and is divided into several individual areas (22).
